(19) United States
(12) Patent Application Publication
(10) Pub. No.: US 2025/0103775 A1
(43) Pub. Date: Mar. 27, 2025

(54) Multi-Objective Optimized Evaluation Method Of Anti-Seismic Performance Of Slope Reinforced By Pile-Anchor System

(71) Applicant: Institute Of Geology And Geophysics, CAS, Beijing (CN)

(72) Inventors: Lei XUE, Beijing (CN); Longfei LI, Beijing (CN); Chao XU, Beijing (CN); Songfeng GUO, Beijing (CN); Hongyan LIU, Beijing (CN); Mengyang ZHAI, Beijing (CN); Xiaolin HUANG, Beijing (CN); Yuan CUI, Beijing (CN); Qiang SUN, Beijing (CN); Guoliang LI, Beijing (CN); Bowen ZHENG, Beijing (CN); Zhiqing LI, Beijing (CN); Jie GUO, Beijing (CN); Haijun ZHAO, Beijing (CN); Xueliang WANG, Beijing (CN)

(21) Appl. No.: 18/640,097

(22) Filed: Apr. 19, 2024

(30) Foreign Application Priority Data
Sep. 26, 2023 (CN) 202311243080.9

(51) Int. Cl. G06F 30/27; G06F 30/13; G06F 111/06; G06F 111/10

(52) U.S. Cl. CPC G06F 30/27; G06F 30/13; G06F 2111/06; G06F 2111/10

(57) ABSTRACT

A multi-objective optimized evaluation method of anti-seismic performance of a slope reinforced by a pile-anchor system is provided. The method includes: training an initial three-dimensional slope numerical calculation model to obtain an target three-dimensional slope numerical calculation model; determining numerical values to be imported into the target three-dimensional slope numerical calculation model according to deformation differences, to obtain a model analysis result; obtaining a simulation operation result according to a reinforcement scheme working condition table of the pile-anchor system; based on the model analysis result and the simulation operation result, evaluating anti-seismic reinforcing performance of the pile-anchor system to obtain comprehensive evaluation values, and then optimizing and evaluating the reinforcement schemes of an overall slope to be reinforced.

### CROSS-REFERENCE TO RELATED APPLICATION

This patent application claims the benefit and priority of Chinese Patent Application No. 202311243080.9 filed on Sep. 26, 2023, the disclosure of which is incorporated by reference herein in its entirety as part of the present application.

### TECHNICAL FIELD

The present disclosure relates to the technical field of anti-seismic reinforcement of slopes in highly seismic areas, in particular to a multi-objective optimized evaluation method of anti-seismic performance of a slope reinforced by a pile-anchor system.

### BACKGROUND

More than two-thirds of China's areas are mountainous areas, which are complex in geological structure, changeable in topography, and prone to landslide disasters under a seismic action, thus seriously restricting the economic and social development of western China. Therefore, an anti-seismic supporting design of slopes under the seismic action has always been one of the research hotspots in geotechnical engineering, and many anti-seismic supporting methods have been put forward one after another. The supporting effect of an anti-slide pile and an anti-slide anchor (cable) has been widely recognized by a large number of practical engineering tests, and their advantages such as a simple construction process and a small disturbance to the slopes enable a pile-anchor combined supporting system to become a common engineering measure in a slope anti-seismic supporting project. However, although the pile-anchor system has excellent anti-seismic performance, the system may still be deformed, damaged and invalidated under the earthquake. There are still problems that the slope reinforced by the pile-anchor system is still unstable, the use efficiency of the pile-anchor structure is low, and the project budget is overspent. Therefore, it is very important to incorporate the anti-seismic performance of the pile-anchor system into the design of a slope anti-seismic reinforcement scheme, to carry out the optimized evaluation of the anti-seismic performance of a slope reinforced by the pile-anchor system in highly seismic areas, and then to obtain a more reasonable anti-seismic reinforcement scheme of the pile-anchor system.

At present, the anti-seismic performance evaluation of the pile-anchor reinforcement system is mainly carried out by the method such as theoretical analysis, model test and numerical simulation. In theoretical analysis, a limit equilibrium method, a Newmark analysis method, etc. are mainly carried out for optimizing the design. Through calculation, the anti-sliding force, the bending moment and the shear force of the anti-sliding pile, and the axial force and the displacement of the anchor rod, which are needed to satisfy the safety of slopes, are obtained, and then the design parameters of the pile-anchor system are given. Although the above methods can give the corresponding design parameters, such methods ignore the safety of the pile-anchor structure itself, fail to take into full account the complexity of the seismic load, and fail to take into account the interaction between the pile-anchor supporting structure and soil. A model test (a centrifuge test, a shaking table test, etc.) is a good research method, which can take into full account the interaction between the pile-anchor supporting structure and rock and soil. However, the accuracy of the test results is greatly influenced by the size effect of the model, similar material properties and boundary conditions, and the test cost is huge. There are often some deviations between the obtained conclusions and the actual situation. The above theoretical analysis and test methods are all non-coupling analysis methods. However, the numerical simulation method can directly analyze the deformation and stress features of the pile-anchor structure under the seismic action and the stability of the reinforced slope on the basis of coupling analysis, and take into account the interaction between the reinforced structure and the slope, which is an ideal research method. The evaluation based on the numerical simulation technology can better reflect the influence of the parameters such as the pile length, the pile spacing and the pile position of an anti-slide pile, and the angle and the position of the anchor rod on the anti-seismic supporting effect of the slope and the anti-seismic performance of the pile-anchor system. However, at present, the evaluation index of most research methods is single, and only the safety factor of the slope or the displacement of the slope is taken as the only optimization objective without considering the safety of the pile-anchor system itself and the dynamic response law of the slope body, which is also the reason why many slopes reinforced by the pile-anchor system are still unstable and damaged under the seismic action. In addition, the existing optimization design method of the pile-anchor system fails to take into full account the coordination and contradiction among various optimization indexes, which may lead to the phenomenon that the optimization design result is contrary to the practical engineering common sense. To sum up, most of the existing research only focuses on the deformation and stability of the slope, ignoring the evaluation of anti-seismic performance of the pile-anchor system.

### SUMMARY

For the above problems existing in the conventional art, the present disclosure aims to provide a multi-objective optimized evaluation method of anti-seismic performance of a slope reinforced by a pile-anchor system. The method may effectively reinforce the slope to be reinforced in a highly seismic area, and may comprehensively take into account the safety of the pile-anchor system itself, the stability of a slope body and a dynamic response law of the slope body by constructing a comprehensive optimization index system about the slope-pile-anchor system in which the slope is to be reinforced. The method may incorporate the anti-seismic performance of the pile-anchor system into the evaluation of a slope anti-seismic reinforcement scheme, which effectively solves the problems of coordination and contradiction among various optimization indexes in the anti-seismic design of the slope reinforced by the pile-anchor system and may provide a new solution to the optimized evaluation of the anti-seismic slope reinforced by the pile-anchor system in the future.

In order to achieve the above purpose, the present disclosure provides the multi-objective optimized evaluation method of anti-seismic performance of the slope reinforced by the pile-anchor system, including: acquiring a plurality of predetermined demand information of an overall slope to be reinforced, and establishing an initial three-dimensional slope numerical calculation model according to the plurality of predetermined demand information of the overall slope to be reinforced; collecting data parameters corresponding to the plurality of predetermined demand information of the overall slope to be reinforced, and training the initial three-dimensional slope numerical calculation model based on the data parameters to obtain an target three-dimensional slope numerical calculation model; acquiring a plurality of survey data of the overall slope to be reinforced, comparing the plurality of survey data with the data parameters corresponding to the plurality of predetermined demand information to obtain deformation differences, and determining numerical values to be imported based on the deformation differences; inputting the numerical values to be imported into the target three-dimensional slope numerical calculation model for analysis to obtain a model analysis result; collecting data information of the pile-anchor system, obtaining a supporting scheme working condition table based on the data information, and performing simulation operation on the slope and the pile-anchor system according to the supporting scheme working condition table to obtain a simulation operation result; and evaluating the anti-seismic performance of the pile-anchor system in a plurality of anti-seismic reinforcement schemes of the overall slope to be reinforced based on the model analysis result and the simulation operation result to obtain comprehensive evaluation values, and optimizing reinforcement schemes of the overall slope to be reinforced according to the comprehensive evaluation values.

In an embodiment, optimization indexes of the overall slope to be reinforced include average displacement of slope surface monitoring points, maximum acceleration amplification factor (AAF) of the slope surface monitoring points, pile displacement, a pile bending moment, a pile shear force, anchor rod displacement and an anchor rod axial force.

In an embodiment, the establishing an initial three-dimensional slope numerical calculation model according to the plurality of predetermined demand information of the overall slope to be reinforced includes: determining first influence information of the overall slope to be reinforced based on the plurality of predetermined demand information, and establishing a first design layer based on a first association between the first influence information and the overall slope to be reinforced; determining second influence information of the overall slope to be reinforced based on the plurality of predetermined demand information, and establishing a second design layer based on a second association between the second influence information and the overall slope to be reinforced; determining n-th influence information of the overall slope to be reinforced based on the plurality of predetermined demand information, and establishing an n-th design layer based on an n-th association between the n-th influence information and the overall slope to be reinforced; determining an association among the first design layer, the second design layer, . . . , and the n-th design layer; and establishing the initial three-dimensional slope numerical calculation model based on the first design layer, the second design layer, . . . , and the n-th design layer and the association.

In an embodiment, the training the initial three-dimensional slope numerical calculation model based on the data parameters to obtain an target three-dimensional slope numerical calculation model includes: classifying the plurality of predetermined demand information, acquiring the data parameters corresponding to the predetermined demand information in a same category, and performing feature matching on different data parameters to determine similar features of all predetermined demand information in the same category; and using the similar features and the data parameters corresponding to all predetermined demand information in the same category as inputs, using performance data of the overall slope to be reinforced as outputs, and training the initial three-dimensional slope numerical calculation model to obtain the target three-dimensional slope numerical calculation model.

In an embodiment, the comparing the plurality of survey data with the data parameters corresponding to the plurality of predetermined demand information to obtain deformation differences, and determining numerical values to be imported based on the deformation differences, includes: carrying out data difference calculation on the plurality of survey data and the data parameters corresponding to the plurality of predetermined demand information, to obtain a plurality of deformation differences; acquiring predetermined deformation differences corresponding to the plurality of deformation differences, and classifying the plurality of deformation differences according to relationships between the plurality of deformation differences and corresponding predetermined deformation differences; classifying a deformation difference into a first data set, in response to the deformation difference being greater than or equal to a corresponding predetermined deformation difference; classifying a deformation difference into a second data set, in response to the deformation difference being smaller than a corresponding predetermined deformation difference; acquiring the number N of all deformation differences and the number N2 of deformation differences in the second data set; determining whether the number N2 of deformation differences in the second data set satisfies N2<[4/N]+1, using deformation differences in the first data set and the deformation differences in the second data set as the numerical values to be imported, in response to a determination that the number N2 of deformation differences in the second data set does not satisfy N2<[4/N]+1; calculating an average value and a variance of the deformation differences in the second data set, in response to a determination that the number N2 of deformation differences in the second data set satisfies N2<[4/N]+1; and calculating a comprehensive deformation difference of the second data set according to the average value and the variance, and using the deformation differences in the first data set and the comprehensive deformation difference as the numerical values to be imported.

In an embodiment, the calculating a comprehensive deformation difference of the second data set according to the average value and the variance includes: calculating the comprehensive deformation difference of the second data set according to the following formula:

$$W = \frac{y 1 + y 2}{2} + \frac{( y 1 - \frac{ymax - y 1}{2} ) + ( y 2 - \frac{ymax - y 2}{2} )}{2} ;$$

where W is the comprehensive deformation difference of the second data set, y1 is the average value of the deformation differences in the second data set, and y2 is the variance of the deformation differences in the second data set; and ymax is a maximal deformation difference in the second data set.

In an embodiment, when evaluating the optimization indexes of the overall slope to be reinforced based on the model analysis result and the simulation operation result to obtain the comprehensive evaluation values, the method includes: extracting data corresponding to the average displacement of slope surface monitoring points, the maximum AAF of slope surface monitoring points, the pile displacement, the pile bending moment, the pile shear force, the anchor rod displacement and the anchor rod axial force; classifying the average displacement of slope surface monitoring points, the maximum AAF of slope surface monitoring points, the pile displacement, the pile bending moment, the pile shear force, the anchor rod displacement and the anchor rod axial force into a first calculation set, a second calculation set and a third calculation set based on performance analysis conditions; and normalizing optimization indexes in the first calculation set, optimization indexes in the second calculation set and optimization indexes in the third calculation set; where the optimization indexes in the first calculation set are normalized according to the following formula:

$${r}_{( i , j )} = A + B \cdot {e}^{\frac{{x}_{( i , j )} - {x}_{( i , j ) max}}{{x}_{( i , j ) max} - {x}_{( i , j ) min}}} ;$$

the optimization indexes in the second calculation set are normalized according to the following formula:

$${r}_{( i , j )} = A + B \cdot {e}^{\frac{{x}_{( i , j ) min} - {x}_{( i , j )}}{{x}_{( i , j ) max} - {x}_{( i , j ) min}}} ;$$

and
the optimization indexes in the third calculation set are normalized according to the following formula:

$${r}_{( i , j )} = \{ \begin{matrix}A + B \cdot {e}^{\frac{{x}_{( i , j )} - {x}_{( i , j ) mid}}{{x}_{( i , j ) mid} - {x}_{( i , j ) min}}} , & {x}_{( i , j ) min} \leq {x}_{( i , j )} \leq {x}_{( i , j ) mid} \\ A + B \cdot {e}^{\frac{{x}_{( i , j ) mid} - {x}_{( i , j )}}{{x}_{( i , j ) mid} - {x}_{( i , j ) min}}} , & {x}_{( i , j ) mid} \leq {x}_{( i , j )} \leq {x}_{( i , j ) max}\end{matrix} ;$$

where r_{(i,j)} is a normalized optimization index value, that is, the relative membership degree, A and B are constants, A+B=100, and x_{(i,j)min}, x_{(i,j)max} and x_{(i,j)mid} are a minimum value, a maximum value and a median of the i-th optimization index in the j-th scheme, respectively.

In an embodiment, the evaluating the anti-seismic performance of the pile-anchor system in a plurality of anti-seismic reinforcement schemes of the overall slope to be reinforced based on the model analysis result and the simulation operation result to obtain comprehensive evaluation values, includes: determining comprehensive weights of the optimization indexes based on subjective weights and objective weights; and calculating the comprehensive evaluation values according to the comprehensive weights and the normalized optimization index values.

In an embodiment, the comprehensive weights of the optimization indexes are calculated according to the following formula:

$${w}_{( i )} = \frac{{w}_{zi} \cdot {w}_{ki}}{{{\sum }_{i = 1}}^{n} {w}_{zi} \cdot {w}_{ki}} ;$$

where w₍ᵢ₎ is a comprehensive weight of the i-th optimization index, and w_{zi} and wₖᵢ indicate a subjective weight and an objective weight, respectively; and
the comprehensive evaluation values are calculated according to the following formula:

$${k}_{( j )} = {\sum }_{i = 1}^{n} {\sum }_{j = 1}^{m} {w}_{( i )} \cdot {r}_{( i , j )} ;$$

where k₍ⱼ₎ is a comprehensive evaluation value.

In an embodiment, when optimizing the reinforcement schemes of the overall slope to be reinforced according to the comprehensive evaluation values, the method includes: according to relationships between the comprehensive evaluation values and predetermined comprehensive evaluation values, determining whether to reinforce the overall slope to be reinforced according to the pile-anchor system, in response to a determination that a comprehensive evaluation value is greater than or equal to a corresponding predetermined comprehensive evaluation value, reinforcing the overall slope to be reinforced according to the pile-anchor system; and in response to a determination that a comprehensive evaluation value is less than a corresponding predetermined comprehensive evaluation value, continuing to optimize and adjust the pile-anchor system.

The present disclosure provides the multi-objective optimized evaluation method of anti-seismic performance of the slope reinforced by the pile-anchor system, which has the following beneficial effects compared with the conventional art.

The present disclosure also provides a multi-objective optimized evaluation method of anti-seismic performance of a slope reinforced by a pile-anchor system comprising a processor; and a memory having programming instructions stored thereon, which, when executed by the processor, cause the processor to implement the above method.

The present disclosure also provides a non-transitory computer-readable medium storing instructions that, when executed, cause a processor to implement the above method.

The initial three-dimensional slope numerical calculation model and the target three-dimensional slope numerical calculation model are established, and the numerical values to be imported are determined, so as to lay a reliable data foundation for the subsequent seismic design of the slope reinforced by the pile-anchor system. According to the present disclosure, a numerical model which takes into account the interaction between the pile-anchor system and the overall slope to be reinforced is constructed, such that various optimization index values under different reinforcement schemes may be quickly and accurately obtained, and the influence of factors such as a size effect, similar material properties, and boundary conditions on the optimization design result is avoided. The evaluation index system in the present disclosure comprehensively takes into account the stability of the slope, the safety of the pile-anchor supporting structure itself and the dynamic response features of the slope, and comprehensively takes into account the factors needing attention in the design of the slope anti-seismic support, which is more scientific. According to the method, the anti-seismic performance of the pile-anchor system is incorporated in the evaluation of the slope anti-seismic reinforcement scheme, thereby obtaining a more reliable slope anti-seismic reinforcement scheme.

### BRIEF DESCRIPTION OF THE DRAWINGS

FIG. 1 shows a schematic flow chart of a multi-objective optimized evaluation method of anti-seismic performance of a slope reinforced by a pile-anchor system according to an embodiment of the present disclosure.

FIG. 2 shows a schematic diagram of the slope reinforced by the pile-anchor system according to an embodiment of the present disclosure.

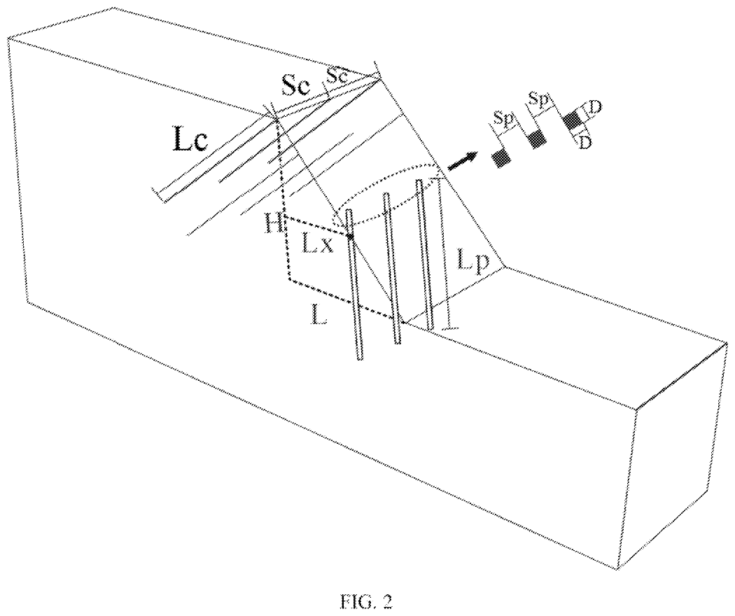

FIG. 3 shows a schematic diagram of arrangement of monitoring points according to an embodiment of the present disclosure.

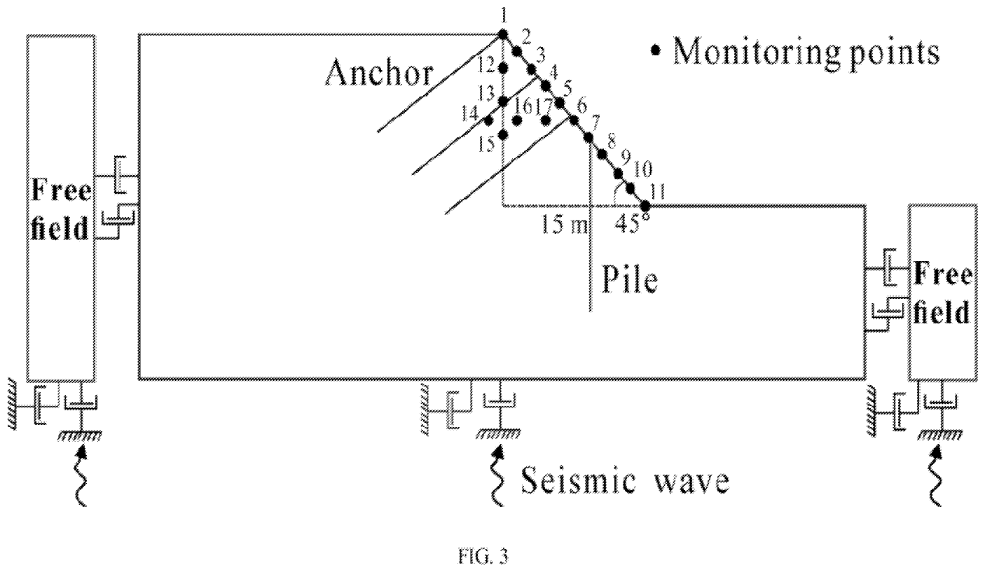

FIG. 4 shows a schematic diagram of an optimization design result according to an embodiment of the present disclosure.

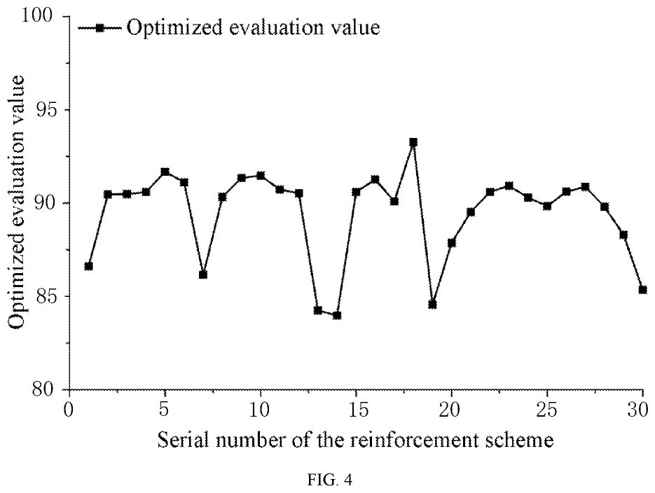

FIG. 5 shows a schematic block diagram of a computer that can be used for implementing the method and the system according to the embodiments of the present disclosure

### DETAILED DESCRIPTION OF THE EMBODIMENTS

The specific embodiments of the present disclosure are described in further detail below in conjunction with the accompanying drawings and examples. The following embodiments are used to illustrate the present disclosure, rather than limit the scope of the present disclosure.

In the description of the present disclosure, it should be noted that the orientational or positional relationships indicated by the terms such as “center”, “up”, “down”, “front”, “back”, “left”, “right”, “vertical”, “horizontal”, “top”, “bottom”, “inside” and “outside” are based on the orientational or positional relationships shown in the drawings only for the convenience of describing the present disclosure and simplifying the description, rather than indicate or imply that the referred devices or elements must have a specific orientation, be constructed and operated in a specific orientation, and therefore should not be construed as limiting the present disclosure.

The terms “first” and “second” are only used for the purpose of description, and cannot be understood as indicating or implying relative importance or implicitly indicating the number of the indicated technical features. Therefore, the features defined as “first” and “second” may include one or more of these features explicitly or implicitly. In the description of the present disclosure, unless otherwise specified, “a plurality of” means two or more.

In the description of the present disclosure, it should also be noted that unless otherwise specified and defined expressly, the terms such as “mount”, “link” and “connect” should be understood broadly, for example, it can be fixed connection, detachable connection or integral connection; or mechanical connection or electrical connection; or direct connection or indirect connection through an intermediate medium, or internal communication of two elements. For those skilled in the art, the specific meanings of the above terms in the present disclosure can be understood according to specific situations.

The following is a description of preferred embodiments of the present disclosure in conjunction with the accompanying drawings.

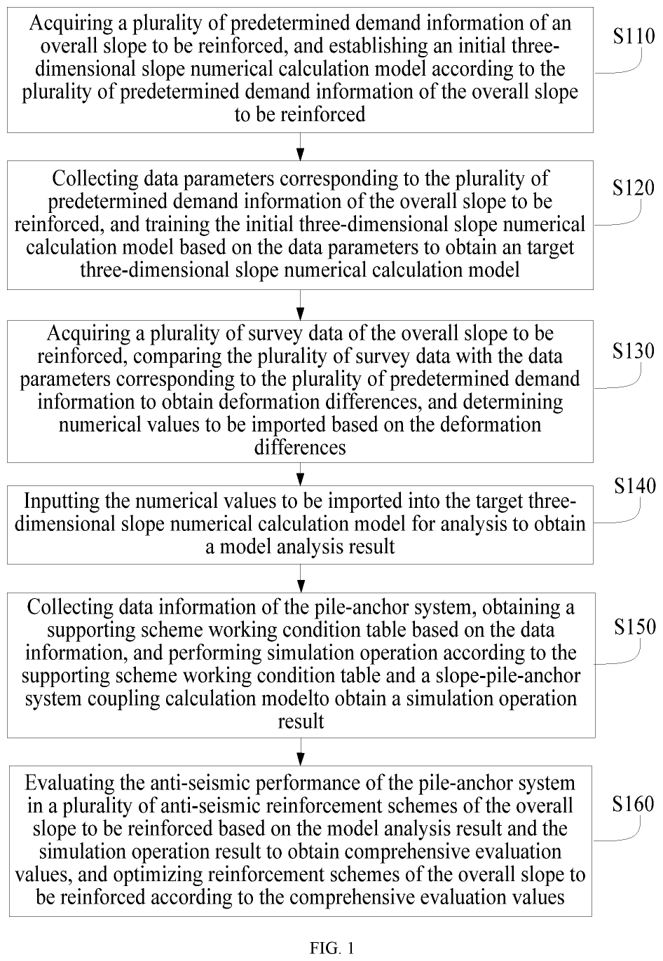

As shown in FIG. 1, an embodiment of the present disclosure provides a multi-objective optimized evaluation method of anti-seismic performance of a slope reinforced by a pile-anchor system, including steps S110-S160.

In step S110, a plurality of predetermined demand information of an overall slope to be reinforced are acquired, and an initial three-dimensional slope numerical calculation model is established according to the plurality of predetermined demand information of the overall slope to be reinforced.

In some embodiments of the present disclosure, the initial three-dimensional slope numerical calculation model is established according to the plurality of predetermined demand information of the overall slope to be reinforced, which includes: determining first influence information of the overall slope to be reinforced based on the plurality of predetermined demand information, and establishing a first design layer based on a first association between the first influence information and the overall slope to be reinforced; determining second influence information of the overall slope to be reinforced based on the plurality of predetermined demand information, and establishing a second design layer based on a second association between the second influence information and the overall slope to be reinforced; determining n-th influence information of the overall slope to be reinforced based on the plurality of predetermined demand information, and establishing an n-th design layer based on an n-th association between the n-th influence information and the overall slope to be reinforced; determining an association among the first design layer, the second design layer, . . . , and the n-th design layer; and establishing the initial three-dimensional slope numerical calculation model based on the first design layer, the second design layer, . . . , and the n-th design layer and the association.

In this embodiment, the predetermined demand information refers to factors such as rock mass properties, geological structures, rock mass structures, and ground stresses of the overall slope to be reinforced. And the monitoring points are arranged on these factors. For example, in the event of an earthquake, these monitoring points can bear pressure or other.

In this embodiment, the first influence information may be rock mass properties, the second influence information may be geological structures, and so on, which are not shown in detail here.

In this embodiment, the first association between the first influence information and the overall slope to be reinforced refers to the influence of rock mass properties on the overall slope to be reinforced in the event of the earthquake, which will not be shown in detail here.

In this embodiment, the initial three-dimensional slope numerical calculation model is obtained by correlating the associated parameters among the first influence information, the second influence information, . . . , and the n-th influence information based on the association, and is the initial three-dimensional slope numerical calculation model obtained by training samples based on the neural network model.

The technical solution has the following beneficial effects. The initial three-dimensional slope numerical calculation model is established through the association among the first influence information, the second influence information, . . . , and the n-th influence information, which is facilitated to the collaborative design, that is the data changes in one layer can be transmitted to other layers effectively in time.

In step S120, data parameters corresponding to the plurality of predetermined demand information of the overall slope to be reinforced are collected, and the initial three-dimensional slope numerical calculation model is trained based on the data parameters to obtain an target three-dimensional slope numerical calculation model.

In some embodiments of the present application, the initial three-dimensional slope numerical calculation model is trained based on the data parameters to obtain the target three-dimensional slope numerical calculation model, which includes: classifying the plurality of predetermined demand information, acquiring the data parameters corresponding to the predetermined demand information in a same category, and performing feature matching on different data parameters to determine similar features of all predetermined demand information in the same category; and using the similar features and the data parameters corresponding to all predetermined demand information in the same category as inputs, taking performance data of the overall slope to be reinforced as outputs, and using the initial three-dimensional slope numerical calculation model to obtain the target three-dimensional slope numerical calculation model.

In this embodiment, the data parameters corresponding to the plurality of predetermined demand information refer to the pressure numerical values that these monitoring points can bear, or other values that the monitoring points can bear.

In this embodiment, the data parameters corresponding to the plurality of predetermined demand information refer to predetermined safety standard numerical values, which may be used as a basis to determine whether the overall slope to be reinforced falls within the safety standard range.

In this embodiment, the plurality of predetermined demand information are classified. That is, the above-mentioned rock mass properties, geological structures, rock mass structures, etc. are classified. For example, rock mass properties and rock mass structures may be classified into one category, both of which belong to the aspect of the rock mass.

In this embodiment, feature matching is performed according to a predetermined matching model. The predetermined matching model is trained in advance according to feature parameters. Similar features refer to similar data parameters of all predetermined demand information in the same category.

The technical solution has the following beneficial effects. The similar features and the data parameters corresponding to all predetermined demand information in the same category are taken as inputs, performance data of the overall slope to be reinforced is taken as outputs, and the initial three-dimensional slope numerical calculation model is trained to obtain the target three-dimensional slope numerical calculation mode, thus laying a foundation for the subsequent determination of the reinforcement scheme of the overall slope to be reinforced.

In step S130, a plurality of survey data of the overall slope to be reinforced are acquired, the plurality of survey data are compared with the data parameters corresponding to the plurality of predetermined demand information to obtain deformation differences, and numerical values to be imported are determined based on the deformation differences.

In some embodiments of the present disclosure, comparing the plurality of survey data with the data parameters corresponding to the plurality of predetermined demand information to obtain the deformation differences, and determining numerical values to be imported based on the deformation differences includes: carrying out data difference calculation on the plurality of survey data and the data parameters corresponding to the plurality of predetermined demand information, to obtain a plurality of deformation differences; acquiring predetermined deformation differences corresponding to the plurality of deformation differences, and classifying the plurality of deformation differences according to relationships between the plurality of deformation differences and the corresponding predetermined deformation differences; in response to a deformation difference being greater than or equal to a corresponding predetermined deformation difference, classifying the deformation difference into a first data set; in response to a deformation difference being smaller than a corresponding predetermined deformation difference, classifying the deformation difference into a second data set; acquiring the number N of all deformation differences and the number N2 of deformation differences in the second data set; determining whether the number N2 of deformation differences in the second data set satisfies N2<[4/N]+1, if not, using the deformation differences in the first data set and the deformation differences in the second data set as the numerical values to be imported; if so, calculating an average value and a variance of the deformation differences in the second data set; and calculating a comprehensive deformation difference of the second data set according to the average value and the variance, and using the deformation differences in the first data set and the comprehensive deformation difference as the numerical values to be imported.

Specifically, the comprehensive deformation difference of the second data set is calculated according to the following formula:

$$W = \frac{y 1 + y 2}{2} + \frac{( y 1 - \frac{y max - y 1}{2} ) + ( y 2 - \frac{y max - y 2}{2} )}{2} ;$$

where W is a comprehensive deformation difference of the second data set, y1 is an average value of the deformation differences in the second data set, and y2 is a variance of the deformation differences in the second data set; and ymax is a maximal deformation difference in the second data set.

In this embodiment, the plurality of survey data refer to actual survey data corresponding to the predetermined demand information, and the predetermined demand information refers to standard data.

In this embodiment, data difference calculation is carried out on the plurality of survey data and the data parameters corresponding to the predetermined demand information to obtain a plurality of deformation differences. For example, if the survey data is 20 and a data parameter corresponding to the predetermined demand information is 25, the deformation difference is 5.

In this embodiment, when the deformation difference is greater than or equal to the corresponding predetermined deformation difference, it indicates that the survey data is quite different from the data parameter corresponding to the predetermined demand information, which leads to a large deviation between the actual performance of the overall slope to be reinforced and the standard performance. Conversely, the deviation is small.

In this embodiment, when the number N2 of deformation differences in the second data set does not satisfy N2<[4/N]+1, it is considered that the data in the second data set will not have a significant influence on the overall research. Therefore, a comprehensive deformation difference is calculated to characterize all deformation differences in the second data set. Conversely, it is considered that the data in the second data set will have a significant influence on the overall research.

In this embodiment, when it is considered that the data in the second data set will have a significant influence on the overall research, in order to avoid affecting the accuracy of the final result, the average value and the variance of the deformation differences in the second data set are calculated, and the comprehensive deformation difference of the second data set is calculated according to the average value and the variance.

The technical solution has the following beneficial effects. According to the present disclosure, the average value and the variance of the deformation differences in the second data set are calculated, and the comprehensive deformation difference of the second data set is calculated according to the average value and the variance, which enables flexible adjustment of data, ensures the accuracy of the output result of the target three-dimensional slope numerical calculation model, and improves the data processing efficiency.

In step S140, the numerical values to be imported are input into the target three-dimensional slope numerical calculation model for analysis to obtain a model analysis result.

In step S150, data information of the pile-anchor system is collected, a supporting scheme working condition table is obtained based on the data information, and simulation operation is performed on the slope and the pile-anchor system according to the supporting scheme working condition table to obtain a simulation operation result.

In step S160, the anti-seismic performance of the pile-anchor system in a plurality of anti-seismic reinforcement schemes of the overall slope to be reinforced is evaluated based on the model analysis result and the simulation operation result to obtain comprehensive evaluation values, and the reinforcement schemes of the overall slope to be reinforced are optimized according to the comprehensive evaluation values.

In some embodiments of the present disclosure, based on the fact that both the slope and the pile-anchor supporting structure itself may be unstable and damaged under the seismic load, the selection of evaluation indexes should comprehensively consider the stability of the slope rock and soil, the safety of the pile-anchor structure itself and the dynamic response features of the slope. In view of this, seven indexes, that is, the average displacement of slope surface monitoring points, the maximum acceleration amplification factor (AAF) of slope surface monitoring points (AAF refers to the ratio of the peak acceleration of slope body monitoring points to the peak acceleration at the foot of the slope, AAF is one of the important indexes for evaluating seismic destructiveness, the greater the AAF value, the greater the impact of earthquakes on buildings and human beings), the pile displacement, the pile bending moment, the pile shear force, the anchor rod displacement and the anchor rod axial force, are comprehensively selected as evaluation indexes for optimized evaluation.

In some embodiments of the present disclosure, when evaluating anti-seismic performance of the pile-anchor system in a plurality of anti-seismic reinforcement schemes of the overall slope to be reinforced based on the model analysis result and the simulation operation result to obtain comprehensive evaluation values, the method includes: extracting data corresponding to the average displacement of slope surface monitoring points, the maximum acceleration amplification factor (AAF) of slope surface monitoring points, the pile displacement, the pile bending moment, the pile shear force, the anchor rod displacement and the anchor rod axial force; classifying the average displacement of slope surface monitoring points, the maximum acceleration amplification factor (AAF) of slope surface monitoring points, the pile displacement, the pile bending moment, the pile shear force, the anchor rod displacement and the anchor rod axial force into a first calculation set, a second calculation set and a third calculation set based on performance analysis conditions; and normalizing the optimization indexes in the first calculation set, the optimization indexes in the second calculation set and the optimization indexes in the third calculation set, where the optimization indexes in the first calculation set are normalized according to the following formula:

$${r}_{( i , j )} = A + B \cdot {e}^{\frac{{x}_{( i , j )} - {x}_{( i , j ) max}}{{x}_{( i , j ) max} - {x}_{( i , j ) min}}} ;$$

the optimization indexes in the second calculation set are normalized according to the following formula:

$${r}_{( i , j )} = A + B \cdot {e}^{\frac{{x}_{( i , j ) min} - {x}_{( i , j )}}{{x}_{( i , j ) max} - {x}_{( i , j ) min}}} ;$$

and
the optimization indexes in the third calculation set are normalized according to the following formula:

$${r}_{( i , j )} = \{ \begin{matrix}A + B \cdot {e}^{\frac{{x}_{( i , j )} - {x}_{( i , j ) mid}}{{x}_{( i , j ) mid} - {x}_{( i , j ) min}}} , & {x}_{( i , j ) min} \leq {x}_{( i , j )} \leq {x}_{( i , j ) mid} \\ A + B \cdot {e}^{\frac{{x}_{( i , j ) mid} - {x}_{( i , j )}}{{x}_{( i , j ) mid} - {x}_{( i , j ) min}}} , & {x}_{( i , j ) mid} \leq {x}_{( i , j )} \leq {x}_{( i , j ) max}\end{matrix} ;$$

where r_{(i,j)} is a normalized optimization index value, that is, the relative membership degree; A and B are constants, A+B=100; and x_{(i,j)min}, x_{(i,j)max} and x_{(i,j)mid} are a minimum value, a maximum value and a median of the i-th optimization index in the j-th scheme, respectively.

In this embodiment, the performance analysis condition means that those the larger numerical valves of which are more preferable belong to a group, those the smaller numerical values of which are more preferable belong to a group, and those the more intermediate numerical values of which are more preferable belong to a group.

In this embodiment, it is assumed that there are m schemes, and each scheme consists of n evaluation indexes. The average displacement of slope surface monitoring points, the maximum acceleration amplification factor (AAF) of slope surface monitoring points, the pile displacement, the pile bending moment, the pile shear force, the anchor rod displacement and the anchor rod axial force are extracted, and each optimization index is normalized by a maximum-minimum normalization method.

The technical solution has the following beneficial effects. In the case of a low fortification intensity and a high strength of the pile-anchor supporting structure itself (that is, strong shearing resistance, bending resistance and tensile resistance (in which the anti-slide pile has a large section and a high strength, the anchor rod has a large section and a high grouting strength)), it is preferably that the two optimization indexes, that is, the average displacement of slope surface monitoring points and the maximum acceleration amplification factor (AAF) of slope surface monitoring points, are as small as possible. It is preferably that the five optimization indexes, that is, the pile displacement, the pile bending moment, the pile shear force, the anchor rod displacement and the anchor rod axial force are close to the middle, so as to give full play to the seismic performance of the pile-anchor reinforced structure. In the case of a high fortification intensity and weak shearing resistance, bending resistance and tensile resistance of the pile-anchor reinforced structure, it is preferably that the seven optimization indexes are as small as possible, so as to fully ensure the safety of the slope body and the pile-anchor reinforced structure under a highly seismic action. To sum up, the pile displacement, the pile bending moment, the pile shear force, the anchor rod axial force, the anchor rod displacement, the average displacement of slope surface monitoring points, and the maximum acceleration amplification factor (AAF) of slope surface monitoring points are selected as evaluation indexes at the same time, which can comprehensively take into account the safety of the pile-anchor system itself, the stability of the slope body and the dynamic response law of the slope body. The problems of coordination and contradiction among various optimization indexes in the anti-seismic design of the pile-anchor reinforcement system are solved, and the anti-seismic performance of the pile-anchor reinforcement system is effectively incorporated in the evaluation.

In some embodiments of the present disclosure, evaluating the optimization indexes of the overall slope to be reinforced based on the model analysis result and the simulation operation result to obtain the comprehensive evaluation values includes: determining comprehensive weights of the optimization indexes based on subjective weights and objective weights; and calculating the comprehensive evaluation values according to the comprehensive weights and the normalized optimization index values.

Specifically, the comprehensive weights of the optimization indexes are calculated according to the following formula:

$${w}_{( i )} = \frac{{w}_{zi} \cdot {w}_{ki}}{{{\sum }_{i = 1}}^{n} {w}_{zi} \cdot {w}_{ki}} ;$$

where w₍ᵢ₎ is a comprehensive weight of the i-th optimization index, and w_{zi} and wₖᵢ indicate a subjective weight and an objective weight, respectively; and
the comprehensive evaluation values are calculated according to the following formula:

$${k}_{( j )} = {\sum }_{i = 1}^{n} {\sum }_{j = 1}^{m} {w}_{( i )} \cdot {r}_{( i , j )} ;$$

where k₍ⱼ₎ is a comprehensive evaluation value.

In this embodiment, a comprehensive weight determining method based on the subjective weight and the objective weight is established. The subjective weight of each index is determined by an ordering relation analysis method, and the objective weight of each index is determined by a variation coefficient method. Finally, the comprehensive weight of each optimization index is obtained by comprehensively weighting the subjective weight and the objective weight.

In this embodiment, the calculation expression of determining the objective weight of the optimization index by the variation coefficient method is as follows:

$${w}_{ki} = \frac{{V}_{i}}{{\sum }_{i = 1}^{n} {V}_{i}} ,$$

where Vᵢ is the variation coefficient of the i-th optimization index.

In this embodiment, the greater comprehensive evaluation value indicates the more optimal and reasonable corresponding reinforcement scheme.

The technical solution has the following beneficial effects. The present disclosure provides a method of determining the comprehensive evaluation value, which not only determines the subjective weight by the ordering relation analysis method, but also takes into account the influence of human factors on the weight of each optimization index. Furthermore, the method also determines the objective weight by the variation coefficient method, which takes into account the influence of data variability on the weight of each optimization index and is more scientific.

In some embodiments of the present disclosure, optimizing the anti-seismic reinforcement schemes of the overall slope to be reinforced according to the comprehensive evaluation values includes: according to relationships between the comprehensive evaluation values and the predetermined comprehensive evaluation values, determining whether to reinforce the overall slope to be reinforced according to the pile-anchor system, in response to a comprehensive evaluation value being greater than or equal to a corresponding predetermined comprehensive evaluation value, reinforcing the overall slope to be reinforced according to the pile-anchor system; and in response to a comprehensive evaluation value being less than a corresponding predetermined comprehensive evaluation value, optimizing and adjusting the pile-anchor system.

The above technical solution has the following beneficial effects. Reliable data support can be provided for whether to reinforce the overall slope to be reinforced according to the pile-anchor system through the relationship between the comprehensive evaluation value and the predetermined comprehensive evaluation value, which takes into full account the coordination and contradiction among various optimization indexes, and ensures that the optimization design result is consistent with practical engineering common sense.

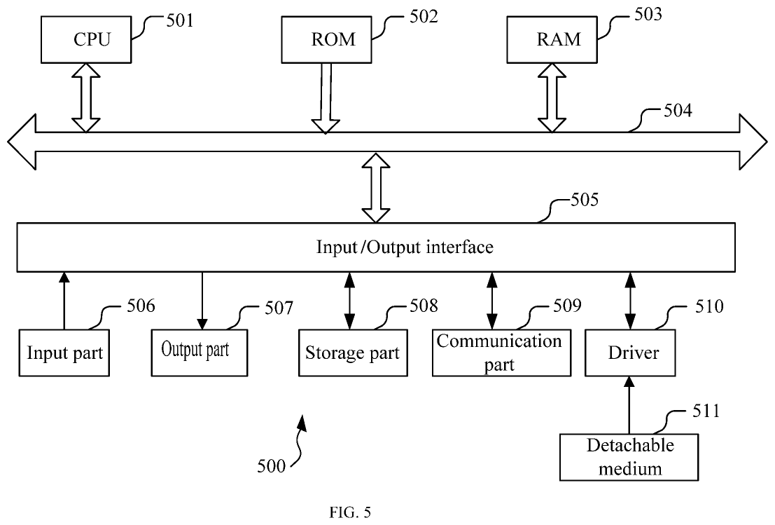

In addition, it should also be noted herein that the respective composite parts in the above system can be configured by software, firmware, hardwire or a combination thereof. Specific means or manners that can be used for the configuration will not be stated repeatedly herein since they are well-known to those skilled in the art. In case of implementation by software or firmware, programs constituting the software are installed from a storage medium or a network to a computer (e.g. the universal computer 500 as shown in FIG. 5) having a dedicated hardware structure; the computer, when installed with various programs, can implement various functions and the like.

FIG. 5 shows a schematic block diagram of a computer that can be used for implementing the method and the system according to the embodiments of the present disclosure.

In FIG. 5, a central processing unit (CPU) 501 executes various processing according to a program stored in a read-only memory (ROM) 502 or a program loaded from a storage part 508 to a random access memory (RAM) 503. In the RAM 503, data needed at the time of execution of various processing and the like by the CPU 501 is also stored according to requirements. The CPU 501, the ROM 502 and the RAM 503 are connected to each other via a bus 504. An input/output interface 505 is also connected to the bus 504.

The following components are connected to the input/output interface 505: an input part 506 (including a keyboard, a mouse and the like); an output part 507 (including a display, such as a Cathode Ray Tube (CRT), a Liquid Crystal Display (LCD) and the like, as well as a loudspeaker and the like); the storage part 508 (including a hard disc and the like); and a communication part 509 (including a network interface card such as an LAN card, a modem and so on). The communication part 509 performs communication processing via a network such as the Internet. According to requirements, a driver 510 may also be connected to the input/output interface 505. A detachable medium 511 such as a magnetic disc, an optical disc, a magnetic optical disc, a semiconductor memory and the like may be installed on the driver 510 according to requirements, such that a computer program read therefrom is installed in the storage part 508 according to requirements.

In the case of carrying out the foregoing series of processing by software, programs constituting the software are installed from a network such as the Internet or a storage medium such as the detachable medium 511.

Those skilled in the art should appreciate that such a storage medium is not limited to the detachable medium 511 storing therein a program and distributed separately from the apparatus to provide the program to a user as shown in FIG. 5. Examples of the detachable medium 511 include a magnetic disc (including floppy disc (registered trademark)), a compact disc (including compact disc read-only memory (CD-ROM) and digital versatile disc (DVD), a magneto optical disc (including mini disc (MD) (registered trademark)), and a semiconductor memory. Or, the storage medium may be hard discs and the like included in the ROM 502 and the storage part 508 in which programs are stored, and are distributed concurrently with the apparatus including them to users.

The present disclosure further proposes a program product storing therein a machine-readable instruction code that, when read and executed by a machine, can implement the aforesaid method according to the embodiment of the present disclosure.

Correspondingly, a storage medium for carrying the program product storing therein the machine-readable instruction code is also included in the disclosure of the present disclosure. The storage medium includes but is not limited to a floppy disc, an optical disc, a magnetic optical disc, a memory card, a memory stick and the like.

In the description of the above embodiments, specific features, structures, materials or characteristics may be combined in any one or more embodiments or examples in a suitable manner.

Although the present disclosure has been described above with reference to embodiments, various improvements can be made thereto and parts thereof can be replaced with equivalents without departing from the scope of the present disclosure. In particular, as long as there is no structural conflict, all the features in the disclosed embodiments of the present disclosure can be combined with each other in any manner, and not all of these combinations are described in this specification only for the sake of omitting space and saving resources. Therefore, the present disclosure is not limited to the specific embodiments disclosed herein, but includes all technical schemes falling within the scope of the claims.

It can be understood by those skilled in the art that the above is only the preferred embodiment of the present disclosure, rather than limit the present disclosure. Although the present disclosure has been described in detail with reference to the foregoing embodiments, it is still possible for those skilled in the art to modify the technical scheme described in the foregoing embodiments or to replace some of its technical features equivalently. Any modification, equivalent substitution, improvement, etc. made within the spirit and principle of the present disclosure should be included in the scope of protection of the present disclosure.

1. A multi-objective optimized evaluation method of anti-seismic performance of a slope reinforced by a pile-anchor system, comprising:
executing method steps by a computer which comprises a target three-dimensional slope numerical calculation model and a slope-pile-anchor system coupling calculation model, said method steps including,
acquiring a plurality of predetermined demand information of an overall slope to be reinforced, and collecting data parameters corresponding to the plurality of predetermined demand information of the overall slope to be reinforced;
acquiring a plurality of survey data of the overall slope to be reinforced, comparing the plurality of survey data with the data parameters corresponding to the plurality of predetermined demand information to obtain deformation differences, and determining numerical values to be imported based on the deformation differences;
inputting the numerical values to be imported into the target three-dimensional slope numerical calculation model for analysis to obtain a model analysis result;
collecting a plurality of data sets of the pile-anchor system that are predesigned as a plurality of anti-seismic reinforcement schemes to obtain a supporting scheme working condition table based on the plurality of data sets, and performing simulation operation according to the supporting scheme working condition table and the slope-pile-anchor system coupling calculation model to obtain a plurality of simulation operation results, wherein each data set comprises a pile length, a pile spacing and a pile position of an anti-slide pile, and an angle and a position of an anchor rod;
evaluating anti-seismic performances of the pile-anchor system in the plurality of anti-seismic reinforcement schemes of the overall slope to be reinforced based on the model analysis result and the plurality of simulation operation results to obtain comprehensive evaluation values; and
outputting, by the computer, the comprehensive evaluation values;
selecting a comprehensive evaluation value that is greater than or equal to a predetermined comprehensive evaluation value from the comprehensive evaluation values; and
establishing a target pile-anchor system comprising the anti-sled pile and the anchor rod based on an anti-seismic reinforcement scheme corresponding to the selected comprehensive evaluation value for reinforcing the overall slope;
wherein optimization indexes of the overall slope to be reinforced comprise average displacement of slope surface monitoring points, maximum acceleration amplification factor (AAF) of the slope surface monitoring points, pile displacement, a pile bending moment, a pile shear force, anchor rod displacement and an anchor rod axial force;
wherein the target three-dimensional slope numerical calculation model is established as follows:
establishing an initial three-dimensional slope numerical calculation model according to the plurality of predetermined demand information of the overall slope to be reinforced, which comprises:
determining a plurality of influence information of the overall slope to be reinforced based on the plurality of predetermined demand information;
establishing a design layer based on a first association between each of the plurality of influence information and the overall slope to be reinforced;
determining a second association among the design layers; and
establishing the initial three-dimensional slope numerical calculation model based on the design layers and the second association; and
training the initial three-dimensional slope numerical calculation model based on the data parameters to obtain the target three-dimensional slope numerical calculation model, which comprises:
classifying the plurality of predetermined demand information, acquiring the data parameters corresponding to the predetermined demand information in a same category, and performing feature matching on different data parameters to determine similar features of all predetermined demand information in the same category; and
using the similar features and the data parameters corresponding to all predetermined demand information in the same category as inputs, using performance data of the overall slope to be reinforced as outputs, and training the initial three-dimensional slope numerical calculation model to obtain the target three-dimensional slope numerical calculation model;
wherein the comparing the plurality of survey data with the data parameters corresponding to the plurality of predetermined demand information to obtain deformation differences, and determining numerical values to be imported based on the deformation differences, comprises:
carrying out data difference calculation on the plurality of survey data and the data parameters corresponding to the plurality of predetermined demand information, to obtain a plurality of deformation differences;
acquiring predetermined deformation differences corresponding to the plurality of deformation differences, and classifying the plurality of deformation differences according to relationships between the plurality of deformation differences and corresponding predetermined deformation differences;
classifying a deformation difference into a first data set, in response to the deformation difference being greater than or equal to a corresponding predetermined deformation difference;
classifying a deformation difference into a second data set, in response to the deformation difference being smaller than a corresponding predetermined deformation difference;
acquiring a number N of all deformation differences and a number N2 of deformation differences in the second data set;
determining whether the number N2 of deformation differences in the second data set satisfies N2<[4/N]+1,
using deformation differences in the first data set and the deformation differences in the second data set as the numerical values to be imported, in response to a determination that the number N2 of deformation differences in the second data set does not satisfy N2<[4/N]+1;
calculating an average value and a variance of the deformation differences in the second data set, in response to a determination that the number N2 of deformation differences in the second data set satisfies N2<[4/N]+1; and
calculating a comprehensive deformation difference of the second data set according to the average value and the variance, and using the deformation differences in the first data set and the comprehensive deformation difference as the numerical values to be imported;
wherein the calculating a comprehensive deformation difference of the second data set according to the average value and the variance comprises:
calculating the comprehensive deformation difference of the second data set according to a following formula:
$$W = \frac{y 1 + y 2}{2} + \frac{( y 1 - \frac{y max - y 1}{2} ) + ( y 2 - \frac{y max - y 2}{2} )}{2} ;$$
wherein W is the comprehensive deformation difference of the second data set, y1 is the average value of the deformation differences in the second data set, and y2 is the variance of the deformation differences in the second data set; and ymax is a maximal deformation difference in the second data set.

2. The multi-objective optimized evaluation method according to claim 1, wherein when evaluating the optimization indexes of the overall slope to be reinforced based on the model analysis result and the plurality of simulation operation results to obtain the comprehensive evaluation values, the method comprises:
extracting data corresponding to the average displacement of the slope surface monitoring points, the maximum AAF of the slope surface monitoring points, the pile displacement, the pile bending moment, the pile shear force, the anchor rod displacement and the anchor rod axial force;
classifying the average displacement of the slope surface monitoring points, the maximum AAF of the slope surface monitoring points, the pile displacement, the pile bending moment, the pile shear force, the anchor rod displacement and the anchor rod axial force into a first calculation set, a second calculation set and a third calculation set based on performance analysis conditions; and
normalizing optimization indexes in the first calculation set, optimization indexes in the second calculation set and optimization indexes in the third calculation set; wherein
the optimization indexes in the first calculation set are normalized according to a following formula:
$${r}_{( i , j )} = A + B \cdot {e}^{\frac{{x}_{( i , j )} - {x}_{( i , j ) max}}{{x}_{( i , j ) max} - {x}_{( i , j ) min}}} ;$$
the optimization indexes in the second calculation set are normalized according to a following formula:
$${r}_{( i , j )} = A + B \cdot {e}^{\frac{{x}_{( i , j ) min} - {x}_{( i , j )}}{{x}_{( i , j ) max} - {x}_{( i , j ) min}}} ;$$
and
the optimization indexes in the third calculation set are normalized according to a following formula:
$${r}_{( i , j )} = \{ \begin{matrix}A + B \cdot {e}^{\frac{{x}_{( i , j )} - {x}_{( i , j ) mid}}{{x}_{( i , j ) mid} - {x}_{( i , j ) min}}} , & {x}_{( i , j ) min} \leq {x}_{( i , j )} \leq {x}_{( i , j ) mid} \\ A + B \cdot {e}^{\frac{{x}_{( i , j ) mid} - {x}_{( i , j )}}{{x}_{( i , j ) mid} - {x}_{( i , j ) min}}} , & {x}_{( i , j ) mid} \leq {x}_{( i , j )} \leq {x}_{( i , j ) max}\end{matrix} ;$$
wherein r_{(i,f)} is a normalized optimization index value, that is, a relative membership degree; A and B are constants, wherein A+B=100; x_{(i,j)min}, x_{(i,j)max} and x_{(i,j)mid} are a minimum value, a maximum value and a median of an i-th optimization index in a j-th scheme, respectively, and x_{(i,j)} is the i-th optimization index in the j-th scheme.

3. The multi-objective optimized evaluation method according to claim 2, wherein evaluating the anti-seismic performance of the pile-anchor system in anti-seismic reinforcement schemes of the overall slope to be reinforced based on the model analysis result and the plurality of simulation operation results to obtain the comprehensive evaluation values comprises:
determining comprehensive weights of the optimization indexes based on subjective weights and objective weights; and
calculating the comprehensive evaluation values according to the comprehensive weights and normalized optimization index values.

4. The multi-objective optimized evaluation method according to claim 3, wherein
the comprehensive weights of the optimization indexes are calculated according to a following formula:
$${w}_{( i )} = \frac{{w}_{zi} \cdot {w}_{ki}}{{{\sum }_{i = 1}}^{n} {w}_{zi} \cdot {w}_{ki}} ;$$
wherein w₍ᵢ₎ is a comprehensive weight of the optimization indexes, and w_{zi} and wₖᵢ indicate a subjective weight and an objective weight, respectively; and
the comprehensive evaluation values are calculated according to a following formula:
$${k}_{( j )} = {\sum }_{i = 1}^{n} {\sum }_{{j = 1}^{}}^{m} {w}_{( i )} \cdot {r}_{( i , j )} ;$$
wherein k₍ⱼ₎ is a comprehensive evaluation value.

5. The multi-objective optimized evaluation method according to claim 1, wherein when evaluating the anti-seismic performance of the pile-anchor system in the reinforcement schemes of the overall slope to be reinforced according to the comprehensive evaluation values, the method further comprises:
in response to a comprehensive evaluation value being less than the predetermined comprehensive evaluation value, optimizing and adjusting a reinforcement scheme of the pile-anchor system corresponding the comprehensive evaluation value.
